(19) United States
(12) Patent Application Publication
(10) Pub. No.: US 2015/0088489 A1
(43) Pub. Date: Mar. 26, 2015

(54) SYSTEMS AND METHODS FOR PROVIDING MAN-MACHINE COMMUNICATIONS WITH ETIQUETTE

(71) Applicant: Abdelhalim Abbas, San Jose, CA (US)

(72) Inventor: Abdelhalim Abbas, San Jose, CA (US)

(21) Appl. No.: 14/032,961

(22) Filed: Sep. 20, 2013

(51) Int. Cl. G06F 17/27; G06F 17/28

(52) U.S. Cl. CPC G06F 17/27; G06F 17/28
USPC 704/9

(57) ABSTRACT

Systems and methods are disclosed for performing man-machine interaction with a user by capturing audible signals and video signals from an environment; detecting a communication context from the audio and video signals; looking up the context in an etiquette database; communicating without disrupting the user and if not possible, determining an appropriate time and fashion to interrupt the user; and communicating with the user at the appropriate time in the appropriate fashion.

### BACKGROUND

This application relates to systems and methods for providing etiquette-based communications.

Many computing devices are now in common daily use outside the traditional use case of one user operating one computer, giving it complete and undivided attention. Examples include:
1. GPS navigation devices, which are commonly used by drivers while operating a vehicle.
2. Using a mobile device like a smart phone while carrying out a conversation with friends on a dinner table
3. Using a laptop computer to take notes or project slides during a business meeting
4. Using a tablet device on a coffee table to shop for furniture together with another friend or family member, conversing about the options while you browse

In addition, and perhaps as a consequence of the above, many human-computer interfaces are now geared more towards audible feedback than before. This is because audible feedback is more intuitive during interactive tasks, and requires less attention and therefore less brainpower than traditional outputs such as textual feedback. For example:
1. Modern GPS navigation devices typically speak out driving directions rather than just displaying them. This is important as the driver is occupied with the task of driving and cannot always afford to focus on the navigation device screen visually.
2. Butler-like mobile frameworks such as Apple Siri, reply to user requests audibly using synthesized speech. This is more convenient given the user if often occupied with one or more other daily life tasks while operating Siri, and cannot be bothered to focus on the screen for answers.
3. Many modern cars now come equipped with an audio interface where the driver issues verbal commands and hears audible confirmation while driving.

However, human-machine interface designers have been neglecting a key difference between audible and visual outputs: It is that audible output is inherently more intrusive than visual output. The reason for this is deeply rooted in human sensory physiology.

Humans have the power to direct their visual attention towards or away from any one particular visual source. For example, one may decide to look at, or look away from a computer screen. With this freedom, users may manage when and how these visual outputs become available for their conscious mind to consume. If a user is in the middle of an important conversation, he can simply delay looking at the screen until the time is convenient.

This is simply not possible with audible outputs, because humans have little to no power to direct their auditory attention to one source to the exclusion of others. Any sufficiently powerful source of sound immediately registers in a human's mind, consuming part of his or her attention span, and requiring deliberate effort to shun away if the time is not convenient. Given all this, human-computer interface designers should handle audible outputs much more carefully than visual outputs, but is not the case in the current market trend.

There is therefore a growing customer need and consequently a market opportunity for a human-computer auditory interface uniquely designed to take into account the social aspects of polite conversation.

### SUMMARY OF THE INVENTION

In one aspect, systems and methods are disclosed for performing man-machine interaction with a user by capturing audible signals and/or video signals from an environment; detecting a communication context from the audio and video signals; looking up the context in an etiquette database; communicating without disrupting the user and if not possible, determining an appropriate time to interrupt the user; and communicating with the user at the appropriate time.

Advantages of the above system may include one or more of the following. The system's machine audio output interface conforms to the requirement of ‘politeness’ altogether and can act as a true social agent with human-like in their behavior and capacity. This includes the ability to learn, to adapt, to formulate and process natural language, and to personalize interaction with every one particular user. The system provides computer output audibly in a way consistent with the social aspects of polite conversation. The system conforms to social rules and conventions around generating audible sounds. The system learns and conforms to social constructs commonly referred to as ‘politeness’ before interrupting a speaker, for example, unless the situation calls for it. The system initiates an audible message only when appropriate, and the system is governed by a set of learned rules of ‘etiquette’ such as not speaking loudly if the ambient noise is too low, not starting a sentence unless when convenient for users to listen, etc. For example, if the system needs to tell a driver about traffic congestion 20 miles ahead, the system might wait a few seconds until the driver is finished saying good morning to a passenger.

### BRIEF DESCRIPTION OF THE DRAWINGS

FIG. 1 shows an exemplary operating environment for a human interaction system.

FIG. 2 shows an exemplary diagram describing an online framework for polite conversations.

FIG. 3 shows an exemplary process for the modeling module in the framework of FIG. 2.

FIG. 4 shows an exemplary process for the planning module in the framework of FIG. 2.

FIG. 5 shows an exemplary diagram outlining the offline learning architecture of the system.

FIG. 6 shows an exemplary process for the training data generation module shown in FIG. 5.

FIG. 7 shows an exemplary process for the rule learning module shown in FIG. 5.

### DESCRIPTION

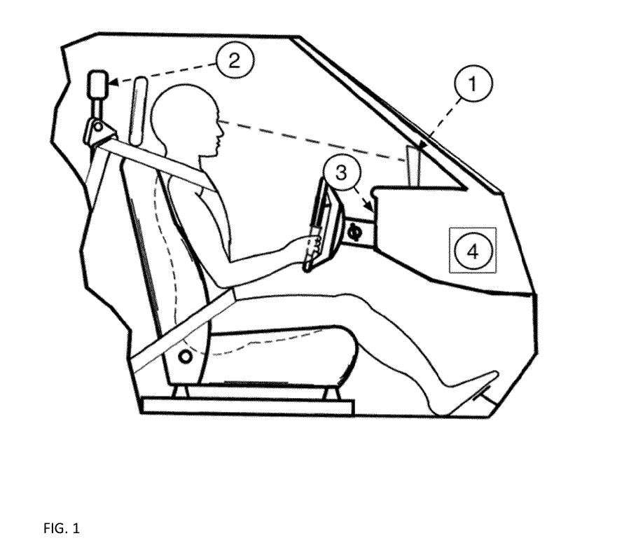

FIG. 1 shows an exemplary operating environment for a human interaction system. In this example, a car environment is discussed. The car includes an on-board camera 1 that provides video input to an on-board computer 4. The computer 4 receives input from a microphone 2 for sound input and drives an onboard speaker 3 to communicate with the driver of the car.

The system of FIG. 1 conforms to social rules and conventions around generating audible sounds in the car. The system conforms to social constructs commonly referred to as ‘politeness’ before interrupting a speaker, for example, unless the situation calls for it. The system initiates an audible message only when appropriate, and the system is governed by a set of learned rules of ‘etiquette’ such as not speaking loudly if the ambient noise is too low, not starting a sentence unless when convenient for other people to listen, etc. For example, if system is required to inform the user about a left turn 20 miles ahead, the system would typically wait until the user is done telling a passenger a short story, or if the message cannot wait, the system would typically interrupt the user at the right moment between two full sentences, with a message that is consistent in wording and duration with what people would consider a polite interjection to a speaker in the middle of a story.

The system's machine audio output interface thus conforms to the conventional requirement of ‘politeness’ altogether and can act as a true social agent with human-like behavior and capacity.

In order for the system to behave in this fashion, it utilizes the microphone 2 and camera 1 in order to model and follow any ongoing conversation between the user and any other agents present in the car, whether they are human or computer agents. The computer 4 continuously receives and analyzes live data feeds from said input devices in real time, in order to construct, manage, and maintain a user conversation model on a virtual timeline. This online framework has access to a database of predetermined rules that represent the conventions of polite conversation, which it uses to make real time decisions of when and how to interject with audible messages. The rules are predetermined using an offline machine learning process and then supplied to the online framework for real time use.

The foregoing was a description of one particular embodiment of the system as an example. The remainder of this section will describe in further detail the online framework as well as the offline learning process.

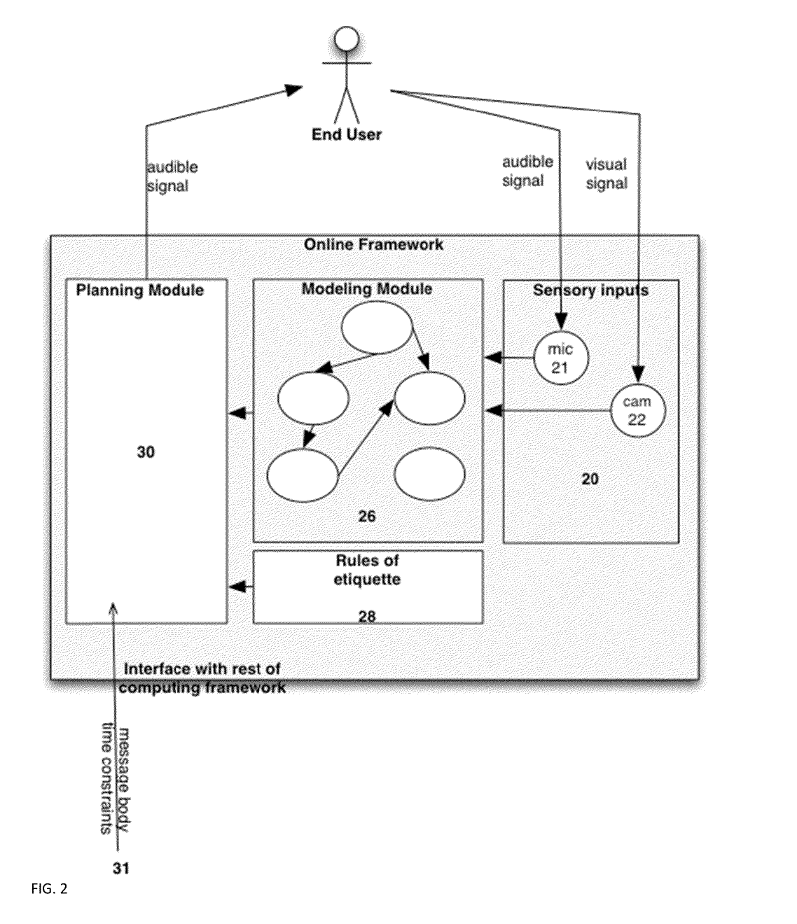

FIG. 2 shows an exemplary diagram describing the generic online framework for polite conversations. The framework includes sensory input module 20 with microphone 21 to capture audible inputs and camera 22 to capture visual inputs from the environment and from the user. The camera is optional, and the system can work with just a microphone recording the sounds in the environment. A conversation modeling module 26 constructs and updates in real time a virtual model of the current state of interaction between the user and any other agents in the surrounding environment such as people or machines. A database 28 stores and serves predetermined rules of etiquette. The model from the modeling module 26 and rules in database 28 are provided to a planning module 30, which interfaces with the other computing generators and frameworks, and based on the rules of etiquette, generates audible signals to the user and/or the environment.

In one embodiment, the sensory module 20 may contain a plurality of microphones and/or a plurality or cameras, placed in carefully chosen physical locations and orientations in order to best capture the interesting aspects of ongoing interactions between people within the desired environment, such as a vehicle or otherwise.

FIG. 2 shows an exemplary request 31 arriving from outside the online framework. Request 31 originates from other computing generators and frameworks that wish to interact with the user audibly. For example, request 31 could originate from a third party daily planner software application that wishes to remind the user audibly that he/she has a phone meeting in 15 minutes. Instead of interfacing directly with the audible output device as is the case in traditional computer systems, request originators use a dedicated API to deliver their messages to the online framework, which acts as an intermediary to enforce the rules of polite communication.

Further, FIG. 2 shows request 31 containing a message body as well as time constraints. The message body may contain one or more literal wordings or formulations of the message to be conveyed to the user. For example, the message body may contain a detailed wording such as “This is a reminder that you have a meeting with the board of directors today at 3:45 PM”, and a brief wording such as “Board of directors meeting at 3:45 pm”. The decision of which message wording to sound to the user is delegated to the planning module of the online framework as appropriate. Request 31 may also contain a temporal constraint such as “message must be delivered no later than 2 minutes from now”. Within such constraint, the decision of exactly when to deliver the audible message is also delegated to the planning module of the online framework as appropriate.

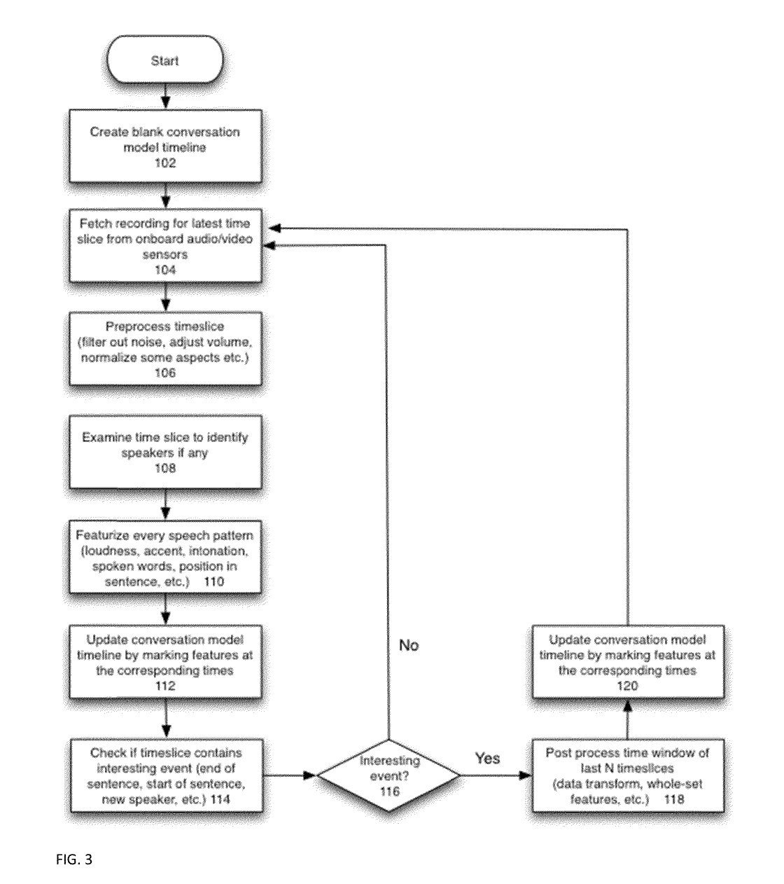

FIG. 3 shows an exemplary process for the modeling module 26 in the framework of FIG. 2. The goal of this modeling process is to create and maintain on a virtual timeline an up to date model of the conversational state of the user with any other agents, whether humans or machines. For example, the current conversational state of the user at one particular moment might be that the user is in the middle of conveying a message to at least two listeners, and that the user said two sentences already, and is currently in the middle of a third sentence expected to finish in 2 seconds. In order to accomplish this goal, the process initially creates a blank conversation model timeline (102). Next, the process fetches a recording for the most recent time slice from the onboard audio/video sensors (104). The length of a time slice is a system parameter chosen for best empirical results. The time slice is preprocessed (106) by performing operations such as filtering noise, volume adjustments, normalization, among others. Next, the process examines the time slice to identify any speakers using standard speech recognition and speaker identification techniques (108). Next, all speech patterns are featurized based on loudness, accent, intonation, spoken words, sentence model features, among others (110). The conversation model timeline is updated by marking the features at the corresponding points on the timeline (112), and the time slice is checked for interesting events such as start/end of a sentence or a new speaker, for example (114). If no interesting event is detected (116), the process loops back to 104 and otherwise the process post-processes a time window of the last N time slices (118) where N is a system parameter chosen for best empirical results. Such post-processing includes, for example, data transformations, computation of whole-set features such as sentence lengths and duration of intra-sentence and inter-sentence pauses, among others. The process then updates the conversation model timeline by marking features at the corresponding times (120). Finally, the process loops back to 104.

This infinite loop of fetching and analyzing audio/visual input one time slice at a time carries on for as long as the system is online. The end result is that the online framework always maintains an up to date virtual model of the current state of any ongoing conversations between the user and any other agents.

In broad embodiment, the same modeling process can be used to model audio situations other than ongoing conversation, such as whether the user is currently listening to any music or radio talk shows, etc.

In broad embodiment, information could be incorporated into the conversation model by means other than audio/video recording. For example, the online framework may be part of a bigger system that also controls music playback, and as such it may be possible for the online framework to know that a music track is currently playing that is due to finish in five seconds. Information from such external source or any other appropriate sources may be incorporated into the process of conversation modeling.

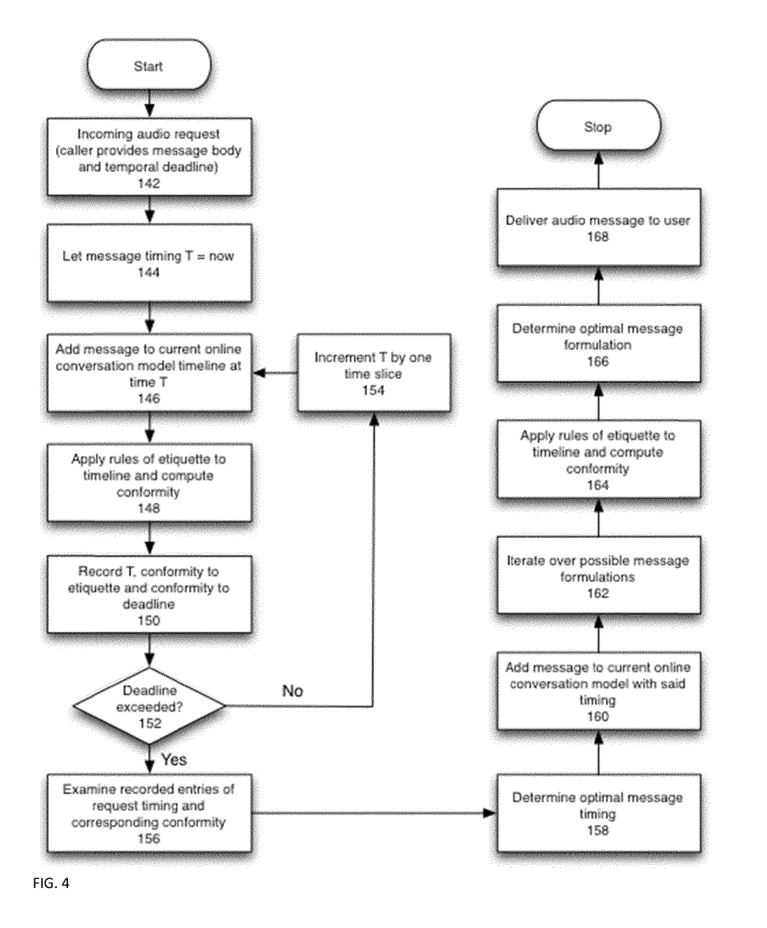

FIG. 4 shows an exemplary process for the planning module 30 in the framework of FIG. 2. The process receives incoming audio output requests from external computer generators and/or frameworks (142). Upon receiving a request, the process considers the effect of delivering the audio message immediately, effectively setting the message timing T=now (144). The process will next add the message to the virtual conversation model timeline at the time T (146). Next, the process applies rules of etiquette to timeline including the newly added message, and computes conformity with the rules of etiquette available to the process via the database 28 (148). After that, the process will record T, conformity to etiquette, and conformity to message deadline (150). The process determines whether placement of message at time T exceeds the message deadline (152). If not, the process will increment T by one slice (154) and repeat the cycle by considering adding the message to virtual conversation model timeline at the incremented time T (146). If T a reaches a moment in time past the message deadline, the process will exit that loop, and examine all recorded entries of message timing and corresponding conformity (156). The process will then determine the optimal message timing (158). Next, the process will add the message to current online conversation model with said timing (160). After, the process will iterate over all possible formulations of the message, as supplied by the caller (162), and apply to each formulation the rules of etiquette to compute conformity (164). The process will then determine the optimal message formulation (166). If the optimal message timing and formulation is deemed to conform poorly to the rules of etiquette, the process may consider pre-pending polite prefixes to the message such as “Excuse me Mark,” in order to boost conformity to the rules of etiquette. Finally, the process will deliver the message to the user at the now determined optimal time using the now determined optimal message formulation (168).

The forgoing was a detailed description of the modules and processes of the online framework of polite conversation. We now describe the offline learning architecture, which is needed to learn and distill the rules of conversational etiquette needed for proper operation of the online framework.

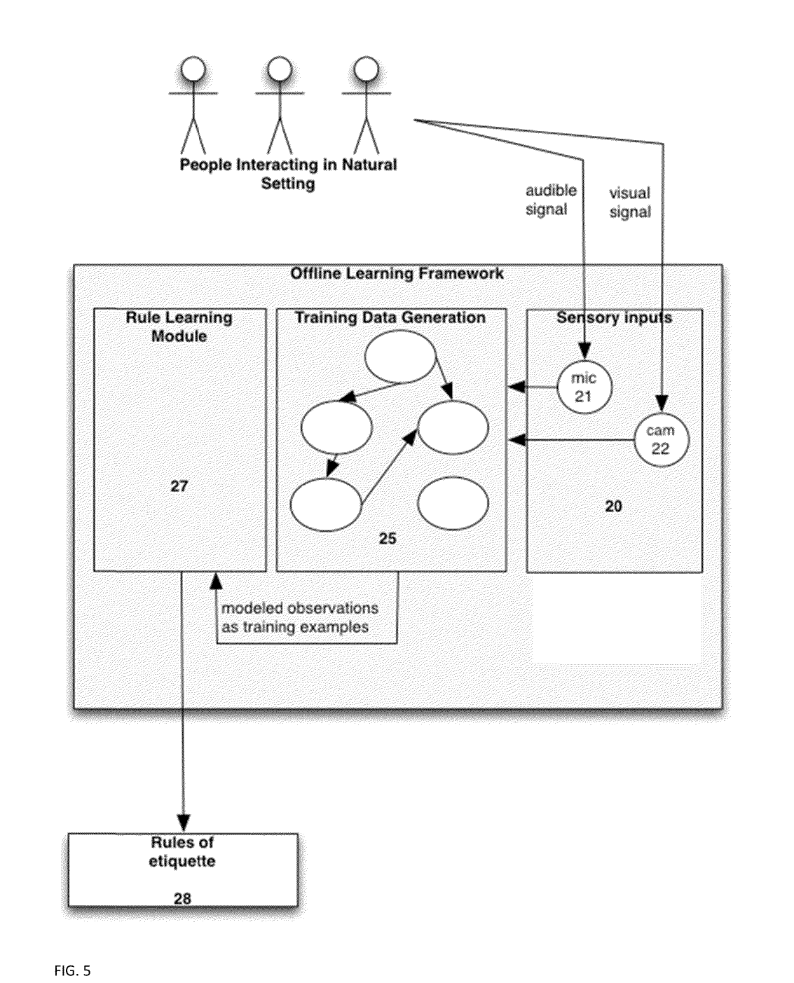

FIG. 5 shows an exemplary diagram outlining the offline learning architecture of the system. The framework includes a sensory input module 20 with microphone 21 to capture audible inputs and camera 22 to capture visual inputs from the environment and users. The camera 22 is optional, and the system can work with just a microphone recording the sounds in the environment. A training dataset generation module 25 is responsible for transforming audio/video feeds from sensory input module 20 into a featurized dataset amenable to machine learning algorithms. A rule learning module 27 receives from 25 a dataset of featurized modeled conversations as training examples, and applies machines learning algorithms in order to learn from training data. The results of the learning module 27 are stored as one or more rules of etiquette in database 28. The rules in database 28 are used in the online framework as previously stated in FIG. 2.

In further detail, still referring to the diagram in FIG. 5, the sensory input module 20 is configured to record audio/video signals from multiple people interacting in natural settings in real life situations. One or more conversations can be recorded, chosen to be exemplary representations of the natural circumstances expected during the operation of the online system. For example, if the system is intended for use onboard a vehicle, multiple real life conversations of people sitting in a moving vehicle can be recorded.

In further detail, still referring to the diagram in FIG. 5, the training data generation module 25 examines recorded conversations one a time, constructing virtual conversation models and timelines for each recorded conversation in a fashion identical to that of the modeling module 26 in FIG. 2, except that module 25 operates on recorded conversations offline instead of live conversations online. The training data generation module 25 next examines every conversational model one time slice at a time, and marks interesting features, which can then be used as training examples by the rule learning module 27.

In further detail, still referring to the diagram in FIG. 5, the rule learning module 27 applies machine learning algorithms on supplied training data in order to learn a set of latent rules that govern polite conversation of people in a natural setting. The rules are stored in database 28 which can be transferred, copied, or reproduced into the online framework for real time operation as outlined in the diagram in FIG. 2. An example of a learned rule may be “starting a message while the user is in the middle of uttering a word within a sentence violates etiquette with a penalty of 4.7”.

In further detail, still referring to the diagram in FIG. 5, various machine learning algorithms can be used to power the rule learning module 27. One embodiment uses supervised learning algorithms which are trained on labeled examples, i.e., input where the desired output is known. The supervised learning algorithm attempts to generalize a function or mapping from inputs to outputs which can then be used to speculatively generate an output for previously unseen inputs. One embodiment uses supervised learning from positive examples only, which is especially convenient in this setting because the recorded conversations supplied generally contain people conforming to rules of etiquette rather than breaking them. One embodiment uses rule-based machine learning algorithms, which attempt to learn logical rules that best explain the training observations. One embodiment uses unsupervised learning algorithms which operate on unlabeled examples, i.e., input where the desired output is unknown. Here the objective is to discover structure in the data (e.g. through a cluster analysis), not to generalize a mapping from inputs to outputs. Semi-supervised learning combines both labeled and unlabeled examples to generate an appropriate function or classifier. One embodiment uses transduction, or transductive inference, which tries to predict new outputs on specific and fixed (test) cases from observed, specific (training) cases. One embodiment uses reinforcement learning which is concerned with how intelligent agents ought to act in an environment to maximize some notion of reward. The agent executes actions which cause the observable state of the environment to change. Through a sequence of actions, the agent attempts to gather knowledge about how the environment responds to its actions, and attempts to synthesize a sequence of actions that maximizes a cumulative reward. One embodiment uses developmental learning, elaborated for Robot learning, which generates its own sequences (also called curriculum) of learning situations to cumulatively acquire repertoires of novel skills through autonomous self-exploration and social interaction with human teachers, and using guidance mechanisms such as active learning, maturation, motor synergies, and imitation.

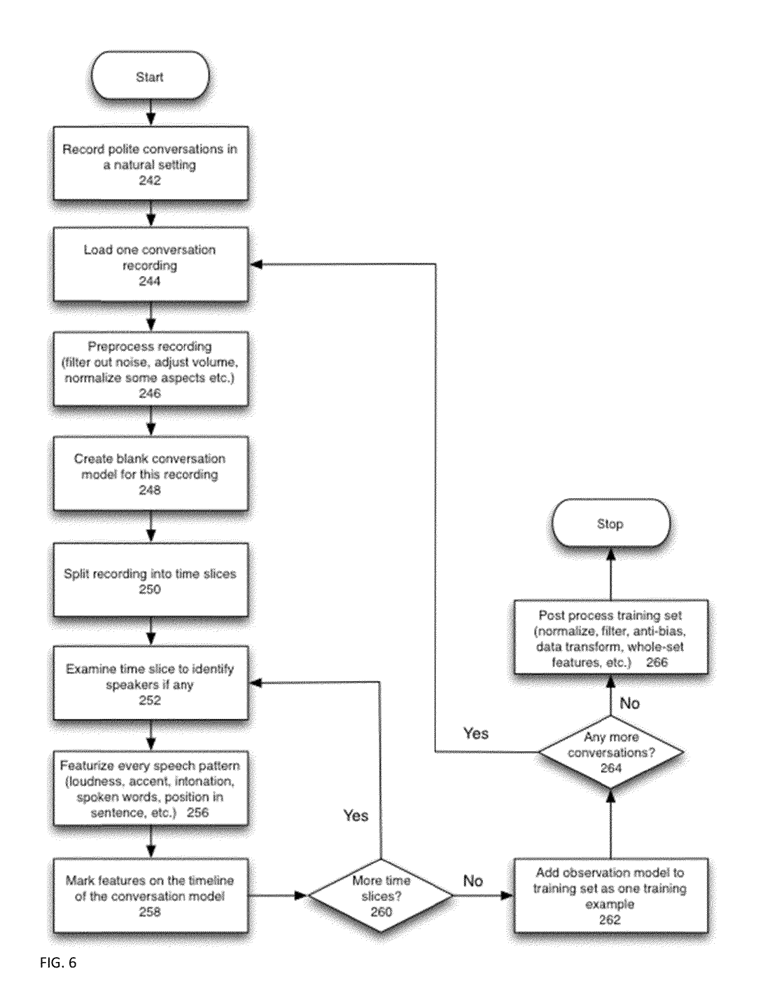

FIG. 6 shows an exemplary process for the training data generation module 25 shown in FIG. 5. The process records polite conversations in a natural setting (242). The process loads the recording of one conversation (244), and performs preprocessing such as filtering noise, adjusting volume, normalizing other aspects of the audio signal, among others (246). Next, a blank conversation model is created for the current recording (248). The recording is split into time slices (250). The process then examines one time slice to identify any speakers (252). The speech from every speaker is featurized to account for loudness, accent, intonation, spoken words, position in sentence, among others (256). The process marks features on the timeline of the conversation model corresponding to the conversation currently being analyzed (258). The process then checks for remaining time slices in the current conversation recording (260) and loops back to 252 to process the time slice, or if done, the process adds the newly featurized conversation model to the training set as an example (262). The process then checks for additional conversations to process (264). If additional conversations remain, then the process looks back to (244) to process the conversations and otherwise the process post-processes the training dataset (266) where the training set can be normalized, filtered, anti-biased, and transformed as needed. Although the foregoing example shows an automated training process, some of the steps are not automatic. For example, the recording of step 242 can be done by having subjects converse in a lab setting and record their conversations.

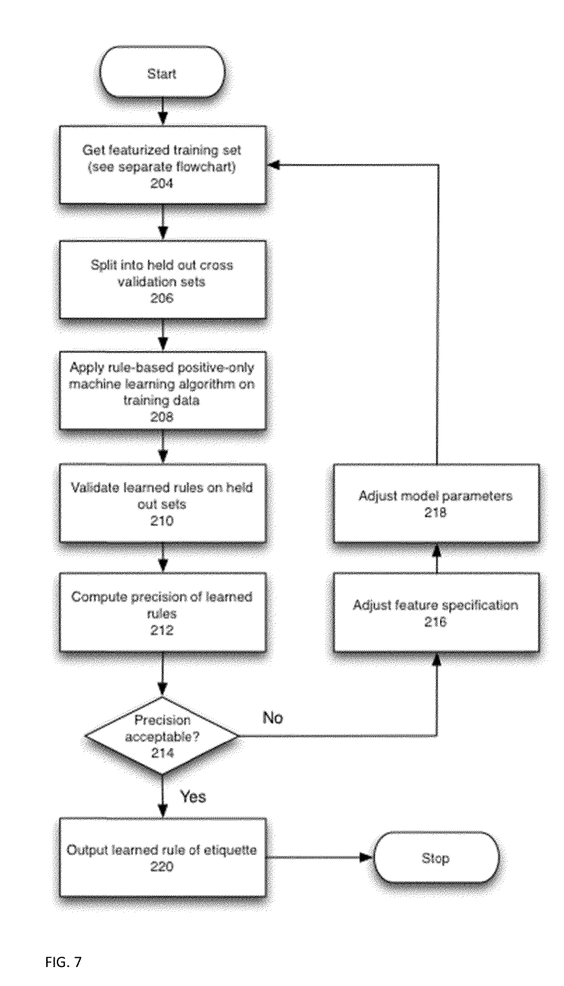

FIG. 7 shows an exemplary process for the rule learning module 27 shown in FIG. 5. The process receives as input a featurized dataset, containing multiple examples, each consisting of a single conversational model having a virtual timeline, with interesting features marked on the timeline at corresponding points in time (204). The process then splits the dataset into training and cross validation subsets (206). After, the process applies rule-based machine learning algorithms on the training data (208). Next, the process validates the learned rules on held out cross validation sets (210). Afterwards, the process computes precision of learned rules (212). The process then decides if the precision is acceptable (214). If it is not, the process adjusts feature specification (216) and adjusts model parameters (218) and then repeats the process from generation of the training set (204). If the precision is acceptable (214), the process outputs the learned rules of etiquette (220).

Although FIG. 1 illustrates operation in a vehicular environment, the system may essentially or selectively be any other elements such as a camera module, a short range communication module, a broadcast receiving module, a digital sound play module such as an MP3 module, an internet access module, a general purpose computing module such as a PC, and the like. According to digital convergence tendencies, such other elements may be varied, modified and improved in various ways, and any other elements equivalent to the above elements may be additionally or alternatively equipped with the preferred embodiment. Meanwhile, as will be understood by those skilled in the art, some of the above-mentioned elements in the car may be omitted or replaced with another elements or functions.

The present invention is described above with reference to flowchart illustrations of user interfaces, methods, and computer program products according to embodiments of the invention. It will be understood that each block of the flowchart illustrations, and combinations of blocks in the flowchart illustrations, can be implemented by computer program instructions. These computer program instructions can be provided to a processor of a general purpose computer, special purpose computer, or other programmable data processing apparatus to produce a machine, such that the instructions, which are executed via the processor of the computer or other programmable data processing apparatus, create means for implementing the functions specified in the flowchart block or blocks. These computer program instructions may also be stored in a tangible computer usable or tangible computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that are executed on the computer or other programmable apparatus provide steps for implementing the functions specified in the flowchart block or blocks.

Each block of the flowchart illustrations may represent a module, segment, or portion of code, which comprises one or more executable instructions for implementing the specified logical function(s). It should be noted that in some alternative implementations, the functions noted in the blocks may occur out of the order shown. For example, two blocks shown in succession may in fact be executed substantially concurrently or the blocks may sometimes be executed in the reverse order, depending upon the functionality involved. The order of implementing the instructions in the blocks is determined by the interrelationship and interaction of the instructions. Thus, instructions that prepared data for subsequent instructions would be known in the art to be performed prior to the subsequent instruction. Otherwise the instructions may be performed in any order.

The above-described methods, according to the present invention, can be implemented in hardware, firmware or as software or computer code that can be stored in a recording medium such as a CD ROM, an RAM, a floppy disk, a hard disk, or a magneto-optical disk or computer code downloaded over a network originally stored on a remote recording medium or a non-transitory machine readable medium and to be stored on a local recording medium, so that the methods described herein can be rendered in such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein.

“Computer readable media” can be any available media that can be accessed by client/server devices. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by client/server devices. Communication media typically embodies computer readable instructions, data structures, program modules or other data in a modulated data signal such as a carrier wave or other transport mechanism and includes any information delivery media.

The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A method for performing man-machine interaction with one or more users, comprising:
capturing audible signals and/or video signals from an environment;
detecting a communication context from the audio and/or video signals;
looking up the context in an etiquette database;
communicating without disrupting the user and if not possible, determining an appropriate time to interrupt the user; and
communicating with the user at the appropriate time.

2. The method of claim 1, comprising analyzing human conversational behavior in a natural setting in order to distill latent rules of polite behavior in conversation.

3. The method of claim 1, comprising using audio and video sensors during a user session in order to model the conversational engagement of user(s) in real time.

4. The method of claim 1, comprising applying rules from the etiquette database with a conversation model to plan a best timing to interject with an audio message, taking into account the importance and time-sensitivity of the message.

5. The method of claim 1, comprising applying rules from the etiquette database with a conversation model to plan a best formulation of an audio message, taking into account the importance and time-sensitivity of the message.

6. The method of claim 1, comprising learning from modeled conversations as training examples.

7. The method of claim 1, comprising interrupting and providing information with etiquette while the user is driving.

8. The method of claim 1, comprising supervising communications from a plurality of devices coupled to a processor.

9. The method of claim 8, comprising communicating with etiquette in a vehicle or a closed environment.

10. The method of claim 1, comprising applying a recognizer to learn the rules of etiquette.

11. A system for performing man-machine interaction with a user, comprising:
a processor;
computer readable code for capturing audible signals and video signals from an environment;
computer readable code for detecting a communication context from the audio and video signals;
computer readable code for looking up the context in an etiquette database;
computer readable code for communicating without disrupting the user and if not possible, determining an appropriate time to interrupt the user; and
computer readable code for communicating with the user at the appropriate time.

12. The method of claim 1, comprising computer readable code for analyzing human conversational behavior in a natural setting in order to distill latent rules of polite behavior in conversation.

13. The method of claim 1, comprising computer readable code for using audio and video sensors during a user session in order to model the engagement of user(s) in real time

14. The method of claim 1, comprising computer readable code for applying rules from the etiquette database with a model to plan a best timing to interject with an audio message, taking into account the importance and time-sensitivity of the message.

15. The method of claim 1, comprising computer readable code for applying rules from the etiquette database with a model to plan a best formulation of audio message, taking into account the importance and time-sensitivity of the message.

16. The method of claim 1, comprising computer readable code for learning from modeled conversations as training examples.

17. The method of claim 1, comprising computer readable code for interrupting and providing information with etiquette while the user is driving.

18. The method of claim 1, comprising computer readable code for supervising communications from a plurality of devices coupled to a processor.

19. The method of claim 8, wherein the device includes at least one of: a global positioning system, an entertainment system.

20. The method of claim 1, comprising computer readable code for applying a recognizer to learn the rules of etiquette.
